(19) United States
(12) Patent Application Publication
(10) Pub. No.: US 2026/0267300 A1
(43) Pub. Date: Sep. 10, 2026

(54) Representation-Embedded Governance Sytems for Fidelity-Adaptive Regulation of Machine Intelligence Execution Without Explicit Control Variables

(71) Applicant: Darren Christopher Tindale, North Vancouver (CA)

(72) Inventor: Darren Christopher Tindale, North Vancouver (CA)

(21) Appl. No.: 19/651,478

(22) Filed: Apr. 17, 2026

Related U.S. Application Data
(63) Continuation-in-part of application No. 19/458,870, filed on Jan. 25, 2026.

(51) Int. Cl. G05B 13/04

(52) U.S. Cl. CPC G05B 13/041

(57) ABSTRACT

Representation-embedded governance systems for regulating execution of machine intelligence processes are disclosed. A computational model generates internal representations that evolve within a constrained representational state space defining execution-permissible and execution-restricted conditions. Execution capability is determined by representational admissibility of the internal representations, such that restricted states structurally preclude formation, representation, dispatch, or execution of operations that lack valid executable mappings to outputs, tool invocations, memory accesses, scheduling entries, or system-level actions. Structural constraints may be encoded in transformation operators, learned parameters, decoder mappings, masks, or dynamical convergence behavior. Within permissible regions, execution availability, fidelity, probability, and resource allocation may be modulated. Execution regulation occurs without computing or evaluating independently defined control variables, providing intrinsic machine-intelligence execution control through representational structure.

### CROSS-REFERENCE TO RELATED APPLICATIONS

The present application is a continuation-in-part of U.S. patent application Ser. No. 19/458,870, filed Jan. 25, 2026, entitled “Dynamic Gated Dual-Pathway Processing Architecture for Regulating High-Fidelity Computation Based on Cumulative Resource Cost,” which is incorporated herein by reference to the extent permitted under 37 CFR § 1.57, except that any subject matter that is inconsistent with the present disclosure shall not be incorporated to the extent of such inconsistency.

The present application is further related to co-pending applications, including:
U.S. patent application Ser. No. 19/538,503, entitled “Cognitive Governance Systems for Fidelity-Adaptive Modulation of Machine Reasoning and Inference Operations”;
U.S. patent application Ser. No. 19/538,467, entitled “Hardware-Implemented Governance Systems for Fidelity-Adaptive Allocation of Computational Resources”;
U.S. patent application Ser. No. 19/538,839, entitled “Adaptive Governance Learning and Economic Arbitration Systems for Fidelity-Adaptive Modulation of Machine Intelligence Execution”;
U.S. patent application Ser. No. 19/540,387, entitled “Lifecycle Governance Systems for Fidelity-Adaptive Modulation of Machine Intelligence Training, Dataset Processing, Simulation, Validation, and Deployment Operations”; and
U.S. patent application Ser. No. 19/550,177, entitled “Distributed Governance Systems for Fidelity-Adaptive Modulation of Multi-Agent Machine Intelligence Execution, Verification, and Security Arbitration”
U.S. patent application Ser. No. 19/636,802, entitled “Unified Multi-Axis Non-Decomposable Governance Architecture for Controlled Execution of Computational Systems”

Each of the foregoing applications is incorporated herein by reference in its entirety to the extent permitted by law. Subject matter disclosed in common with the parent application and related applications is entitled to the priority date of Jan. 25, 2026, under 35 U.S.C. § 120.

Subject matter disclosed herein that extends beyond the parent application and related applications includes governance architectures in which execution regulation is intrinsically embedded within internal representational state structures and is not performed through explicit computation or evaluation of independently defined control variables. Such subject matter constitutes continuation-in-part disclosure entitled to the filing date of the present application.

Nothing in this cross-reference shall be construed as an admission that any incorporated subject matter constitutes prior art against the present disclosure.

### STATEMENT REGARDING FEDERALLY SPONSORED RESEARCH OR DEVELOPMENT

No federally sponsored research or development was involved in the creation of this invention.

### FIELD OF THE INVENTION

The present disclosure relates generally to governance architectures for regulating execution of computational processes. More specifically, the disclosure pertains to representation-embedded governance systems configured to regulate execution of machine intelligence operations based on intrinsic properties of internal representational states. Embodiments of the present disclosure operate across multiple technological domains, including but not limited to:
neural network inference execution systems;
generative artificial intelligence architectures;
machine learning and deep learning systems;
distributed and multi-agent computational systems;
adaptive compute allocation and execution control infrastructures; and
hardware-accelerated and software-defined execution environments.

The disclosed systems enable intrinsic regulation of computational execution by constraining execution behavior through representational state structure, rather than through explicit evaluation of control variables or externally applied arbitration mechanisms.

### BACKGROUND OF THE INVENTION

### 5.1 Growth of Machine Intelligence Execution Systems

Advances in artificial intelligence, machine learning, and generative modeling have resulted in computational systems capable of performing increasingly complex inference, reasoning, and decision-making operations. Modern machine intelligence systems operate on high-dimensional internal representations, including:
latent embeddings;
attention-weighted feature states;
token probability distributions;
multimodal fusion representations; and
context-dependent activation states.

Execution of such systems involves dynamic allocation of computational resources across inference pathways, reasoning depth, and supporting infrastructure components.

### 5.2 Existing Execution Governance Approaches

Conventional systems regulate execution of computational processes through explicit control mechanisms, including:
computation of representational divergence or uncertainty metrics;
accumulation of computational resource expenditure metrics;
application of threshold-based decision logic; and
implementation of policy-based arbitration mechanisms.

Such approaches evaluate control variables derived from execution telemetry and apply governance decisions to regulate computational behavior. In certain systems, control policies are learned through reinforcement learning or other optimization processes. However, such systems still rely on decision outputs or computed signals to constrain or modulate execution behavior.

### 5.3 Limitations of Explicit and Decision-Based Control Systems

Existing execution governance approaches exhibit several limitations. First, reliance on explicitly computed control variables introduces computational overhead and latency associated with telemetry acquisition, metric computation, and arbitration processing. Second, separation between execution pathways and governance mechanisms results in architectures in which execution remains universally accessible in principle, and control is applied only after evaluation has occurred. Third, decision-based control systems, including those utilizing learned policies, regulate execution through outputs of computational processes rather than through structural constraints on execution capability.

As a result, such systems may:
permit execution pathways that provide limited or no benefit relative to computational cost;
require continuous evaluation of control signals; and
remain susceptible to approximation, substitution, or circumvention of control variables.

### 5.4 Absence of Intrinsic Execution Constraint Architectures

Existing systems do not provide architectures in which execution capability is defined as an intrinsic property of internal representational state structure.

In conventional approaches:
representational states are inputs to computational processes; and
governance decisions are applied through separate evaluation mechanisms.

Execution capability is therefore determined through: the evaluation of control variables followed by the application of control decisions.

Conventional systems generally do not define execution capability such that: the existence, accessibility, or formability of computational operations is structurally constrained by representational state itself.

### 5.5 Need for Representation-Embedded Governance Systems

There exists a need for computational architectures in which:
execution capability is intrinsically constrained by internal representational states;
execution pathways are structurally inaccessible when representational conditions are not satisfied;
execution behavior is regulated without reliance on explicit computation of control variables; and
governance is embedded within representational structure rather than implemented through separate arbitration mechanisms.

Such architectures would enable:
reduction of computational overhead associated with explicit governance;
structural enforcement of execution constraints;
intrinsic alignment between representational fidelity and computational behavior; and
improved robustness against circumvention of control mechanisms.

The present disclosure addresses these needs by introducing representation-embedded governance systems in which execution capability is determined as a function of representational admissibility within a constrained representational state space.

### SUMMARY OF THE INVENTION

The present disclosure introduces representation-embedded governance systems and methods configured to regulate execution of computational processes based on intrinsic properties of internal representational states. Such internal representations may encode information relating to system state; however, such information is not computed, extracted, or evaluated as an independent control variable governing execution. Rather, execution capability is determined directly by the structural properties of the representational state itself, without formation or evaluation of an intermediate control metric. Conventional computational governance systems regulate execution through explicit evaluation of control variables, including representational divergence metrics, computational resource expenditure metrics, and policy-based decision outputs. Such systems rely on computation, aggregation, and evaluation of control signals to determine execution behavior. In contrast, embodiments of the present disclosure provide architectures in which execution capability is determined as a function of representational state structure, without requiring explicit evaluation of independently defined control variables.

In one or more embodiments, a computational system comprises a computational model configured to generate internal representations during execution. The internal representations evolve within a representational state space having structural constraints that define:
execution-permissible representational states; and
execution-restricted representational states.

Execution capability of one or more computational operations is determined based on the internal representations occupying the representational state space. In certain embodiments, the structural constraints of the representational state space render at least a subset of computational operations inaccessible, non-executable, or non-formable when the internal representations correspond to execution-restricted representational states. In some embodiments, execution behavior of the computational process is modulated as a function of the internal representations.

Such modulation may include variation in:
accessibility of computational operations;
allocation of computational resources;
execution fidelity;
execution probability; and
activation of execution pathways.

In certain embodiments, representational evolution is governed by one or more of:
transformation operators applied to internal representations;
learned parameter structures defining constrained representational manifolds; and
dynamical system behavior, including convergence toward attractor states associated with execution-permissible conditions.

In some embodiments, structural constraints are encoded within learned parameters of the computational model such that execution-permissible states are reinforced and execution-restricted states are suppressed during operation.

In certain embodiments, execution-restricted representational states result in suppression of computational pathway activation, restriction of execution operations, or inability to form valid executable operations within the computational process. In some embodiments, representation-embedded governance operates independently of, or in conjunction with, auxiliary control mechanisms. In such embodiments, internal representations independently constrain or modulate execution behavior irrespective of the presence of additional control systems. A defining characteristic of the disclosed systems is that execution regulation is performed without requiring computation, evaluation, or comparison of explicit control variables, including divergence metrics, cumulative resource expenditure metrics, integrity signals, or externally supplied authority states. Accordingly, the present disclosure provides a distinct governance paradigm in which execution capability is structurally determined by representational admissibility within a constrained representational state space, enabling intrinsic regulation of computational execution without reliance on explicit arbitration mechanisms. In contrast to the parent application, which regulates execution through computation and evaluation of control signals derived from integrated metrics including cumulative resource expenditure and representational divergence, the present disclosure provides governance architectures in which execution regulation is intrinsically embedded within internal representational state structure and is not performed through explicit computation or evaluation of independently defined control variables.

### BRIEF DESCRIPTION OF THE DRAWINGS

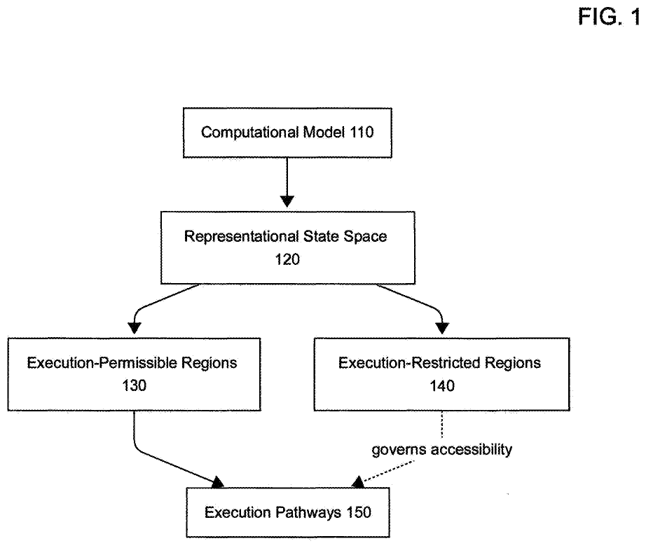

The accompanying drawings illustrate exemplary embodiments of the representation-embedded governance architectures described herein and form part of the present specification. The drawings are provided for purposes of illustration and are not intended to limit the scope of the invention.
FIG. 1 illustrates an exemplary representation-embedded execution governance architecture 100, comprising:
a computational model 110 configured to generate internal representations during execution;
a representational state space 120 within which the internal representations evolve;
a set of execution-permissible regions 130 defined within the representational state space;
a set of execution-restricted regions 140 defined within the representational state space; and
one or more execution pathways 150 whose accessibility is governed by the internal representations occupying the representational state space 120.

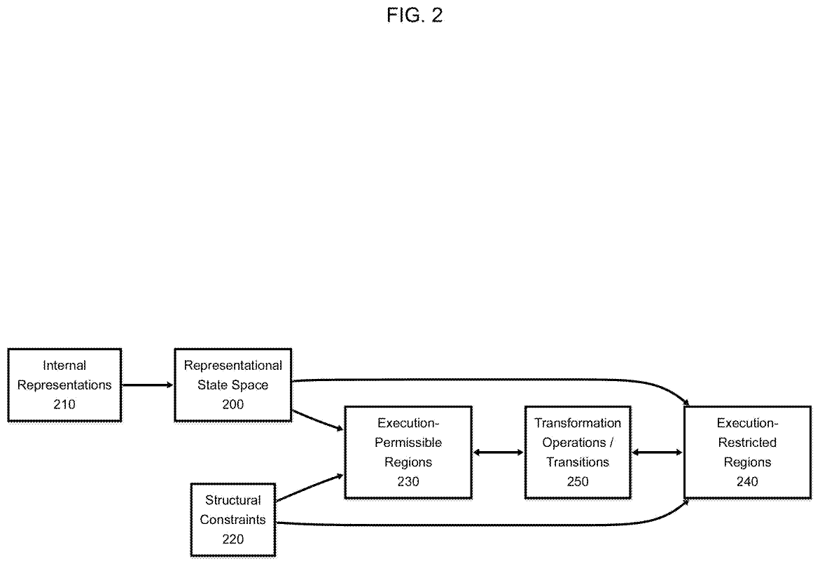

FIG. 2 illustrates an exemplary representational state space framework 200, in which:
internal representations 210 evolve within the representational state space;
structural constraints 220 define boundaries between execution-permissible regions 230 and execution-restricted regions 240; and
transitions 250 between representational regions occur as a result of transformation operations applied to the internal representations.

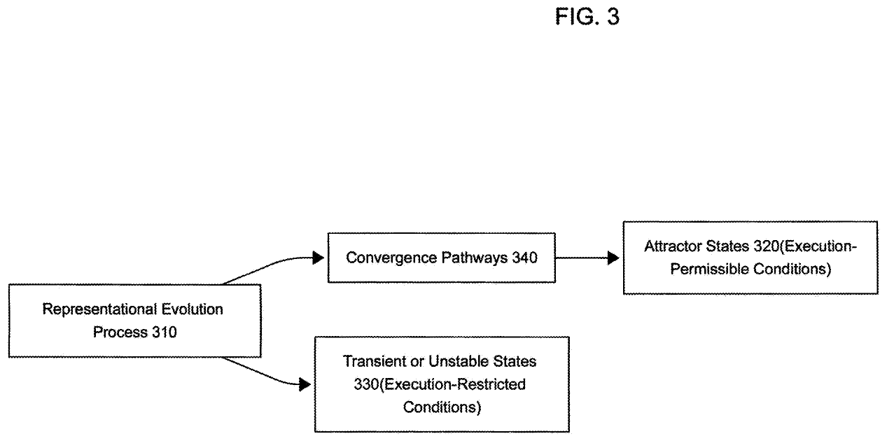

FIG. 3 illustrates an exemplary dynamical governance framework 300, comprising:
a representational evolution process 310 governed by dynamical system behavior;
one or more attractor states 320 corresponding to execution-permissible conditions;
transient or unstable states 330 corresponding to execution-restricted conditions; and
convergence pathways 340 along which internal representations transition toward the attractor states 320.

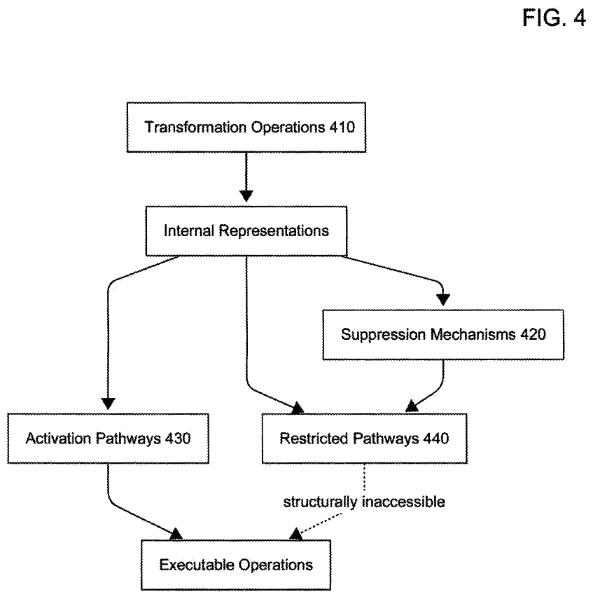

FIG. 4 illustrates an exemplary transformation-constrained execution architecture 400, comprising:
one or more transformation operators 410 applied to internal representations;
suppression mechanisms 420 configured to attenuate or nullify representations corresponding to execution-restricted states;
activation pathways 430 that are accessible when representations correspond to execution-permissible states; and
restricted pathways 440 that are structurally inaccessible when representations correspond to execution-restricted states.

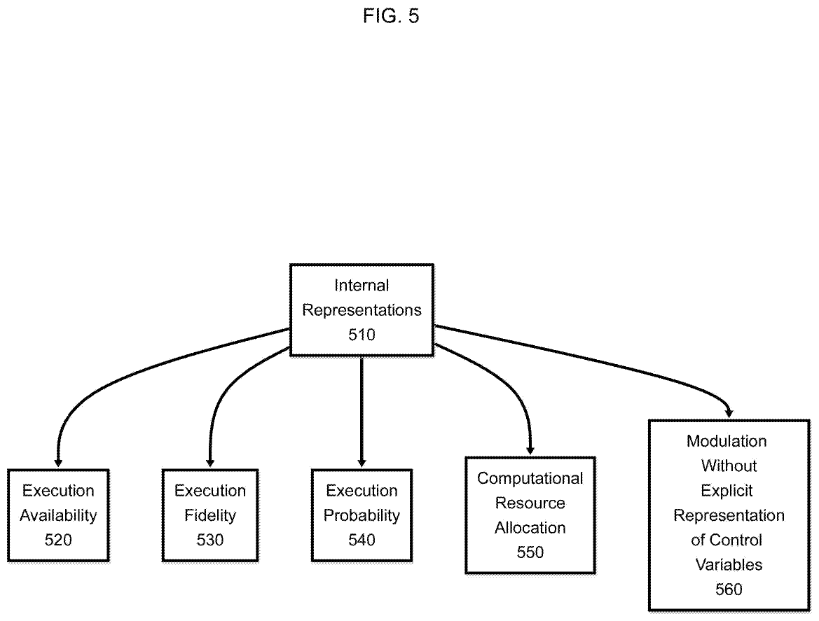

FIG. 5 illustrates an exemplary execution modulation framework 500, in which:
internal representations 510 constrain or modulate execution characteristics of a computational process;
execution availability 520, execution fidelity 530, execution probability 540, and computational resource allocation 550 are modulated as a function of the internal representations; and
modulation occurs without explicit representation of control variables.

### DETAILED DESCRIPTION OF THE INVENTION

### 8.1 Overview of Representation-Embedded Governance Architecture

Referring to FIG. 1, an exemplary representation-embedded execution governance architecture 100 is illustrated. The architecture 100 comprises a computational model 110 configured to generate internal representations during execution of a computational process. The internal representations evolve within a representational state space 120, which defines execution-permissible regions 130 and execution-restricted regions 140. Execution pathways 150 are accessible or structurally inaccessible as a function of the internal representations occupying the representational state space 120. In contrast to conventional governance systems, execution capability within architecture 100 is not determined through evaluation of control variables, but instead is structurally determined by the representational state itself.

### 8.2 Representational State Space and Structural Constraints

Referring to FIG. 2, the representational state space framework 200 comprises internal representations 210 evolving within a constrained state space. Structural constraints 220 define boundaries separating execution-permissible regions 230 from execution-restricted regions 240. Transitions 250 between representational regions occur through application of transformation operations to the internal representations.

In certain embodiments, structural constraints 220 are defined by:
architectural limitations of transformation operators;
learned parameter structures;
activation constraints; or
representational manifold restrictions.

Execution capability is determined by whether the internal representations 210 occupy execution-permissible regions 230 or execution-restricted regions 240.

### 8.3 Structural Enforcement of Execution Constraints

Referring to FIG. 4, transformation-constrained execution architecture 400 illustrates structural enforcement mechanisms. Transformation operators 410 act on internal representations to produce subsequent representational states. Suppression mechanisms 420 attenuate or nullify representations corresponding to execution-restricted states. Activation pathways 430 are accessible when internal representations correspond to execution-permissible states, while restricted pathways 440 are structurally inaccessible when internal representations correspond to execution-restricted states.

In certain embodiments, execution-restricted states:
prevent formation of executable instruction sequences;
inhibit propagation of activation signals;
restrict or prevent allocation of computational resources or addressability of memory regions at the processor, memory, or execution scheduling level; or
disable execution pathways at the level of computational operations.

Such enforcement occurs without computation or evaluation of explicit control variables.

In certain embodiments, non-formability of computational operations includes conditions in which valid executable representations, instruction sequences, or computational outputs cannot be generated by the computational model due to representational constraints, such that execution cannot be realized even in the absence of external control signals or decision mechanisms.

In certain embodiments, such prevention of execution arises from representational states that do not correspond to valid parameterized mappings within the computational model, such that no executable transformation path exists from the given representational state to a valid output state.

In certain embodiments, execution-restricted representational states are not merely associated with reduced likelihood or diminished activation of computational operations, but correspond to representational conditions for which no valid executable mapping exists within the computational model. Accordingly, computational operations associated with such states are not executable even in principle, rather than being suppressed through probabilistic weighting, attenuation, or continuous modulation of execution parameters. In certain embodiments, structural constraints are implemented through execution masks or gating matrices derived directly from internal representational encodings, wherein representational states corresponding to execution-restricted conditions generate mask configurations that prevent formation or dispatch of executable operations at a processor, kernel, or instruction level. In certain embodiments, such structural constraints are not defined by externally specified symbolic rules or static validation logic, but arise from learned or dynamically evolving representational encodings within the computational model. In certain embodiments, such structural constraints preclude formation of executable operations at both model output levels and system-level execution interfaces. In certain embodiments, such structural constraints preclude not only execution of operations, but also formation of syntactically or semantically valid executable representations required to initiate execution. In such embodiments, non-formability includes conditions in which no syntactically valid, semantically valid, or structurally admissible representation exists within the defined computational output space.

### 8.4 Dynamical System Embodiments

Referring to FIG. 3, dynamical governance framework 300 comprises representational evolution process 310 governed by dynamical system behavior.

In certain embodiments:
attractor states 320 correspond to execution-permissible conditions;
transient or unstable states 330 correspond to execution-restricted conditions; and
convergence pathways 340 define transitions toward attractor states.

Execution capability is enabled when internal representations converge toward attractor states 320, and restricted when representations remain in transient or unstable states 330.

Dynamical behavior may be defined by:
recurrent transformation processes;
energy minimization dynamics;
stability constraints; or
iterative convergence operations.

### 8.5 Learned Constraint Embedding

In certain embodiments, structural constraints of the representational state space are encoded within learned parameters of the computational model 110.

Training processes may:
reinforce execution-permissible representations;
suppress execution-restricted representations; and
shape representational manifolds to enforce admissibility conditions.

Such encoding may be achieved through:
loss functions penalizing non-permissible states;
regularization constraints;
training data selection; or
architectural parameterization.

Execution regulation is thereby embedded within model parameters rather than computed during runtime through explicit evaluation.

### 8.6 Modulation of Execution Characteristics

Referring to FIG. 5, execution modulation framework 500 illustrates how internal representations 510 constrain or modulate execution characteristics.

In certain embodiments, internal representations modulate:
execution availability 520;
execution fidelity 530;
execution probability 540; and
computational resource allocation 550.

Such modulation occurs as a function of representational state, without computation of explicit control variables.

In some embodiments, modulation may be:
discrete, resulting in full suppression or activation; or
continuous, resulting in partial restriction or probabilistic variation in execution behavior.

In such embodiments, modulation occurs within execution-permissible regions of the representational state space, whereas execution-restricted regions correspond to structural non-formability conditions in which valid executable mappings do not exist.

In various embodiments, the disclosed architectures may be categorized into:
(i) structural exclusion embodiments, in which execution-restricted representational states correspond to conditions in which computational operations are non-formable, non-executable, or lack valid executable mappings;
(ii) graded modulation embodiments, in which execution behavior varies continuously within execution-permissible representational states without structural elimination of execution capability; and
(iii) hybrid embodiments, in which structural exclusion governs execution-restricted states while graded modulation governs execution-permissible states.

### 8.7 Hybrid Governance Architectures

In certain embodiments, representation-embedded governance operates in conjunction with auxiliary control mechanisms.

Such auxiliary mechanisms may include:
policy-based controllers;
scheduling systems;
resource allocation frameworks; or
external orchestration systems.

However, in such embodiments, internal representations independently constrain or modulate execution characteristics, and execution behavior remains dependent on representational admissibility. In such embodiments, auxiliary control mechanisms do not define execution admissibility, which remains structurally determined by representational state.

### 8.8 Absence of Explicit Control Variables

A defining characteristic of the disclosed architecture is that execution regulation is performed without reliance on explicit control variables.

The system does not require computation, evaluation, or comparison of:
divergence metrics;
cumulative resource expenditure metrics;
integrity signals; or
externally supplied authority states.

Execution capability is instead determined solely by the structural properties of representational state within the computational process. The existence of internal representational values, activation states, or latent variables that correlate with execution behavior does not constitute computation or evaluation of an explicit control variable, provided that execution regulation is not performed through extraction, comparison, or evaluation of such values as independently defined governing metrics. In such embodiments, execution regulation is not performed by computing, extracting, or evaluating any intermediate scalar, vector, or derived quantity representing execution desirability, cost, or priority. Instead, execution capability is directly determined by the existence or absence of valid representational mappings within the computational model.

### 8.9 Architectural Distinction

The disclosed architecture differs from conventional systems in which:
execution is determined through threshold-based evaluation;
control variables are computed and aggregated; or
arbitration engines generate control decisions.

In the present disclosure:
execution capability is structurally constrained by representational state, and computational operations are permitted, restricted, or modulated based on representational admissibility within a constrained state space. In conventional computational systems, internal representations may influence selection, routing, or prioritization of computational operations; however, such systems do not structurally constrain execution capability. In such systems, computational operations remain formable and executable in principle, even if not selected or activated. In contrast, in the present disclosure, execution capability is structurally constrained by representational state such that certain computational operations are not formable, not accessible, or not executable when the internal representations correspond to execution-restricted states. This distinction defines a difference between conditional execution and structural constraint of execution capability.

In contrast to architectures described in related applications employing control mechanisms based on computed metrics and explicit gating signals, the present disclosure defines execution capability as an intrinsic structural property of representational state, independent of any intermediate evaluation or control signal generation. In certain embodiments, the structural constraint of execution capability is distinct from selection-based or routing-based mechanisms in which computational operations remain executable but are not selected. In the present disclosure, execution-restricted conditions correspond to absence of valid executable mappings, rather than conditional selection among available operations.

### 8.10 Implementation Considerations

The disclosed systems may be implemented across a variety of computational environments, including:
software-defined inference systems;
hardware-accelerated processing systems;
distributed computational architectures; and
hybrid hardware-software systems.

Structural constraints may be enforced at:
model architecture level;
transformation layer level;
execution pipeline level; or
system infrastructure level.

By way of non-limiting example, in certain embodiments, a neural network-based system may be configured such that internal representational states correspond to activation patterns within intermediate layers that do not map to valid downstream computational outputs unless such representations fall within execution-permissible regions of the representational state space.

In one example implementation, transformation operators comprise learned projection layers configured to map internal representations to output distributions or instruction sequences, wherein representations corresponding to execution-restricted states are mapped to invalid, suppressed, or non-activating outputs such that executable operations cannot be formed.

In certain embodiments, decoder or output-generation mechanisms are configured such that representations corresponding to execution-restricted states do not correspond to any valid token, instruction, or executable output within a defined output space, thereby preventing downstream execution due to absence of valid output encoding. In such embodiments, execution-restricted representational states do not merely reduce likelihood of execution, but prevent formation of valid executable outputs at the model level, thereby enforcing structural constraints on execution capability without reliance on externally computed control signals. In certain embodiments, representational admissibility determines whether structured action outputs, including API calls, tool invocations, or executable command sequences, can be formed, such that execution-restricted representational states prevent formation of syntactically or semantically valid executable action representations. In certain embodiments, representational admissibility further governs memory access, such that execution-restricted representational states correspond to representations that do not map to valid memory address vectors or retrieval keys within an addressing space, thereby preventing memory retrieval operations from being formed or executed. By way of illustrative example, in a transformer-based language model, internal representations corresponding to intermediate token embeddings may be projected through a decoder layer configured to generate output tokens or executable action sequences. In execution-restricted representational states, the projection mapping produces outputs that do not correspond to any valid token, command, or structured action within the defined output space, such that no syntactically or semantically valid executable representation can be formed. As a result, downstream execution cannot occur, not due to suppression or selection among available outputs, but due to absence of any valid executable representation arising from the internal representational state. In certain embodiments, representational admissibility determines whether execution requests are addressable within a scheduling system. Representational states corresponding to execution-restricted conditions may generate execution requests that do not correspond to any valid scheduling entry, resource allocation mapping, or executable instruction within the scheduling infrastructure, thereby preventing execution at the system level without reliance on computed control variables.

### 8.11 Non-Limiting Nature of Embodiments

The foregoing embodiments are illustrative and non-limiting.

Various modifications, substitutions, and alternative implementations may be made without departing from the scope of the present disclosure.

No element, feature, or limitation described herein is intended to be essential unless explicitly stated as such.

### INTERPRETATION, SCOPE, AND CLAIM CONSTRUCTION PROVISIONS

### 9.1 General Principles of Interpretation

The present disclosure is intended to be interpreted in a non-limiting manner.

The descriptions of embodiments provided herein are illustrative and are not intended to limit the scope of the claimed invention. Variations, modifications, and alternative implementations will be apparent to those of ordinary skill in the art in view of the present disclosure.

Unless explicitly stated otherwise, no element, feature, or limitation described herein is required for all embodiments.

### 9.2 Singular and Plural Usage

Unless the context clearly indicates otherwise:
singular terms shall be interpreted to include the plural; and
plural terms shall be interpreted to include the singular.

For example, reference to “a computational model” includes one or more computational models.

### 9.3 Open-Ended Claim Language

The terms “comprising,” “including,” “having,” and similar terms are intended to be open-ended and mean “including but not limited to.”

The use of such terms does not exclude the presence of additional elements, features, or components beyond those expressly recited.

### 9.4 Functional and Structural Language

Where elements are described in functional terms, such descriptions are intended to encompass any structure capable of performing the recited function.

Where elements are described in structural terms, such descriptions are intended to encompass equivalent structures and configurations capable of achieving the same or similar functionality.

### 9.5 Module and Component Interpretation

References to modules, subsystems, components, or elements are not intended to imply any specific physical or logical separation unless explicitly stated.

Such elements may be:
implemented as discrete components;
integrated within a single system; or
distributed across multiple systems or processing environments.

### 9.6 Implementation Independence

The disclosed systems and methods may be implemented in:
software;
hardware;
firmware; or
any combination thereof.

Implementation details may vary without departing from the scope of the invention. 9.7 Non-Exclusivity of Embodiments

The embodiments described herein are not mutually exclusive.

Features, elements, or aspects of one embodiment may be combined with those of other embodiments unless such combination is explicitly stated to be incompatible.

### 9.8 Absence of Disclaimer

No statement in this specification is intended to constitute a disclaimer of subject matter not explicitly recited in the claims.

No embodiment, feature, or description should be interpreted as limiting the scope of the claims unless explicitly set forth in the claims.

### 9.9 Claim Scope and Equivalents

The scope of the invention is defined by the claims and includes all equivalents of the claimed elements and limitations.

Equivalent elements may include:
structural equivalents;
Functional Equivalents; and
variations that perform substantially the same function in substantially the same way to achieve substantially the same result.

### 9.10 Interpretation of Representational State Terminology

References to “internal representations,” “representational state space,” “execution-permissible states,” and “execution-restricted states” are intended to encompass any internal computational states, structures, or configurations that influence or determine execution behavior within a computational process.

Such representations may include, without limitation:
latent embeddings;
activation states;
attention distributions;
feature maps;

### Multimodal Representations; and

any other internal state constructs generated during execution of machine intelligence systems.

References to “application programming interface (API) calls,” “tool invocations,” or “executable command sequences” are intended to encompass any structured representation, instruction format, or invocation mechanism by which a computational system initiates, triggers, or executes an operation, including representations that must satisfy syntactic, semantic, or structural validity conditions in order to correspond to executable operations or valid system-level actions.

### 9.11 Interpretation of Execution Capability and Modulation

References to “execution capability,” “execution behavior,” or “modulation of execution” are intended to encompass any variation in computational operation, including:
availability or accessibility of computational operations;
formation or suppression of executable operations;
variation in computational fidelity or precision;
probabilistic execution behavior; and
allocation or restriction of computational resources.

### 9.12 Non-Requirement of Explicit Control Variables

Where the disclosure describes execution regulation as occurring without computation or evaluation of explicit control variables, such description is intended to distinguish from systems requiring independent computation and evaluation of such variables.

This does not exclude implementations in which auxiliary signals, internal states, or derived values may exist within a computational process, provided that execution regulation is not performed through explicit evaluation of independently defined control variables as a governing mechanism.

### ABSTRACT

Representation-embedded governance systems for regulating execution of machine intelligence processes are disclosed. A computational model generates internal representations that evolve within a constrained representational state space. Structural properties of the representational state space define execution-permissible and execution-restricted conditions. Execution capability of computational operations is determined as a function of the internal representations occupying the representational state space, such that at least a subset of computational operations are inaccessible or non-executable when the internal representations correspond to execution-restricted conditions. In certain embodiments, representational state transitions are governed by transformation operators, learned parameter structures, or dynamical system behavior, including convergence to attractor states associated with execution-permissible conditions. Execution behavior may be modulated as a function of the internal representations, including variation in execution availability, execution fidelity, execution probability, and computational resource allocation. Execution regulation is performed without requiring explicit computation or evaluation of independently defined control variables, including divergence metrics, cumulative resource expenditure metrics, integrity signals, or authority states. The disclosed architectures provide intrinsic regulation of computational execution through representational admissibility conditions, enabling fidelity-adaptive modulation of machine intelligence processes without reliance on explicit governance controllers or multi-variable arbitration mechanisms.

1. A system for regulating execution of a computational process, comprising:
one or more processors configured to execute a computational model that generates internal representations during operation;
wherein the computational model is configured such that the internal representations evolve within a representational state space having structural constraints defining: (i) a set of execution-permissible representational states, and (ii) a set of execution-restricted representational states;
wherein execution capability of one or more computational operations is determined as a function of the internal representations occupying the representational state space;
wherein the structural constraints of the representational state space structurally preclude formation or execution of at least a subset of computational operations when the internal representations correspond to execution-restricted representational states, including conditions in which no valid executable mapping exists from the internal representations to a valid output, executable operation, or executable system-level action;
wherein the structural preclusion is not merely a selection, routing, suppression, masking, or blocking among independently formable computational operations, but comprises structural constraint of execution capability by representational admissibility within the representational state space:
and wherein the system regulates execution without computing or evaluating independently defined control variables governing execution.

2. A system for regulating execution of a computational process, comprising:
one or more processors configured to execute a computational model that generates internal representations during operation;
wherein execution behavior of the computational process is modulated as a direct function of structural properties of the internal representations;
wherein the internal representations constrain or modulate execution characteristics within execution-permissible representational states, including at least one of: (i) accessibility of computational operations, (ii) allocation of computational resources, (iii) execution fidelity, (iv) execution probability, or (v) activation of execution pathways;
wherein a representational state space further comprises execution-restricted representational states corresponding to structural non-formability conditions in which no valid executable mapping exists to a valid output, executable operation, or executable system-level action, and wherein the modulation occurs within the execution-permissible representational states;
wherein the computational operations remain formable and executable within execution-permissible regions of the representational state space, but vary as a function of the internal representations;
wherein the modulation of execution behavior is performed without requiring explicit computation or evaluation of independently defined control variables governing execution;
and wherein the modulation does not arise from selection among independently executable operations, but from structural variation in execution capability defined by the internal representations.

3. The system of claim 1, wherein the representational state space comprises a constrained latent manifold in which permissible representational states are restricted to a subset defined by one or more structural encoding constraints.

4. The system of claim 1, wherein the structural constraints of the representational state space are defined by transformation functions that selectively attenuate or eliminate representations that do not satisfy execution-permissible conditions.

5. The system of claim 1, wherein execution-restricted representational states are structurally incapable of producing valid downstream computational outputs due to transformation-induced elimination of executable pathways.

6. The system of claim 1, wherein the internal representations evolve according to a dynamical system characterized by one or more attractor states, and wherein execution is enabled upon convergence to an attractor state.

7. The system of claim 6, wherein non-convergent or transient representational states correspond to execution-restricted conditions.

8. The system of claim 1, wherein structural constraints of the representational state space are encoded within learned parameters of the computational model.

9. The system of claim 8, wherein the learned parameters are trained such that execution-permissible representational states correspond to regions associated with stable or semantically valid outputs.

10. The system of claim 8, wherein training enforces suppression of representations corresponding to execution-restricted states through one or more loss functions that penalize formation of non-permissible representations.

11. The system of claim 1, wherein execution-restricted representational states prevent formation of executable instruction sequences within the computational process.

12. The system of claim 1, wherein execution-permissible representational states enable propagation of computational signals through one or more execution pathways that are inaccessible to execution-restricted states.

13. The system of claim 1, wherein execution-restricted representational states result in suppression of one or more of computational pathway activation, memory access operations, or processor-level execution events.

14. The system of claim 1, wherein execution-restricted representational states prevent or limit allocation of processing resources at one or more of a processor level, memory level, or execution scheduling level.

15. The system of claim 2, wherein execution behavior is modulated within execution-permissible representational states such that computational fidelity or execution precision is reduced without preventing execution.

16. The system of claim 1, wherein transformation operators comprise learned projection layers configured to map internal representations to output distributions, and wherein execution-restricted representations are mapped to invalid or non-activating outputs.

17. The system of claim 1, wherein the internal representations correspond to token embeddings in a transformer-based model, and wherein execution-restricted representational states prevent formation of valid token outputs by causing the token embeddings to lack a valid decoder mapping to a valid token, instruction, executable command representation, or structured action representation, rather than merely applying an externally supplied grammar, schema, post-generation filter, or output-only token mask.

18. The system of claim 1, wherein execution-restricted representational states prevent formation of executable tool invocation structures within an agent-based system, including by producing no syntactically valid and semantically addressable tool invocation, API call, function-call object, command sequence, or structured action object capable of being accepted by a downstream execution interface.

19. The system of claim 1, wherein representational admissibility determines eligibility for execution scheduling at a processor or system level, including whether an execution request maps to a valid scheduling entry, processor-level dispatch representation, resource-allocation mapping, executable instruction, or system-level execution-interface representation.

20. The system of claim 1, wherein representational state determines accessibility of memory retrieval operations within a computational process, including whether the representational state maps to a valid memory address vector, retrieval key, memory-access representation, or resource-access representation.

21. The system of claim 2, wherein execution probability of one or more computational operations varies as a continuous function of the internal representations.

22. The system of claim 2, wherein execution behavior is constrained or modulated by both the internal representations and one or more auxiliary control mechanisms, and wherein the internal representations independently constrain or modulate execution characteristics.

23. The system of claim 2, wherein modulation of execution behavior occurs independent of a separate arbitration engine configured to compute a unified evaluation metric.

24. The system of claim 2, wherein execution capability is continuously modulated while remaining subject to structural constraints of the representational state space such that computational operations vary in accessibility, fidelity, or probability.

25. A method for regulating execution of a computational process, comprising:
generating, by a computational model executed by one or more processors, internal representations during execution;
evolving the internal representations within a representational state space having structural constraints defining execution-permissible and execution-restricted representational states;
determining execution capability of one or more computational operations based on the internal representations occupying the representational state space; and
structurally precluding formation, representation, or execution of at least a subset of computational operations when the internal representations correspond to execution-restricted representational states, including conditions in which no valid executable mapping exists to a valid output, executable operation, or executable system-level action;
wherein the structural precluding is not merely selecting, routing, suppressing, masking, blocking, or filtering among independently formable operations, but comprises structural constraint of execution capability by representational admissibility within the representational state space:
wherein execution regulation is performed without computing or evaluating independently defined control variables governing execution.

26. The system of claim 1, wherein the computational model is trained such that structural constraints of the representational state space are encoded within learned parameters that prevent formation of representations corresponding to execution-restricted representational states, including through one or more training objectives, loss functions, regularization constraints, training-data selections, or architectural parameterizations that penalize mappings from execution-restricted representational states to valid executable outputs or reinforce mappings from execution-permissible representational states to valid executable outputs.

27. The system of claim 1, wherein execution-restricted representational states correspond to regions of an output space that do not map to any valid token, instruction, or executable command representation, and wherein the absence of such mapping arises from representational admissibility within the computational model rather than solely from an externally supplied grammar, schema, symbolic validation rule, regular expression, or post-generation filter.

28. The system of claim 1, wherein structural constraints are implemented through execution masks derived from internal representations that prevent formation or dispatch of executable operations, wherein the execution masks are derived from internal representational admissibility within the constrained representational state space and prevent formation or dispatch of executable operations by eliminating valid executable mappings rather than by selecting among independently executable operations.

29. The system of claim 1, wherein execution-restricted representational states prevent allocation of computational resources by rendering associated execution requests non-addressable within a scheduling system, memory-access interface, processor-level dispatch interface, system-level execution interface, or resource-allocation interface.
